(19) United States
(12) Patent Application Publication
(10) Pub. No.: US 2008/0121283 A1
(43) Pub. Date: May 29, 2008

(54) Device and method for regulating a level of fluid in a vessel

(76) Inventor: Gene Stauffer, Moreno Valley, CA (US)

Correspondence Address: STETINA BRUNDA GARRED & BRUCKER, 75 ENTERPRISE, SUITE 250, ALISO VIEJO, CA, 92656, US

(21) Appl. No.: 11/985,451

(22) Filed: Nov. 15, 2007

Related U.S. Application Data
(60) Provisional application No. 60/860,952, filed on Nov. 27, 2006.

(51) Int. Cl. F17D 3/01; F16K 21/18; F17D 1/08

(52) U.S. Cl. 137/12; 137/386

(57) ABSTRACT

A system for regulating a level of fluid in a vessel is provided that is capable of detecting a pressure of the fluid, and increasing and/or decreasing a flow of fluid to the vessel in relation to the detected pressure. The system can contain a fluid level regulator adapted to pass a fluid therethrough and having a pressure detector, as well as an inlet hose connecting the regulator to a fluid supply and an outlet hose connecting the regulator to the vessel. The system provides a non-intrusive and convenient means of fluid level regulation and maintenance for a variety of different vessel types, including decorative fountains and bird baths, pools and ponds, and water heating and storage tanks, among others.

### CROSS-REFERENCE TO RELATED APPLICATIONS

This application claims priority to provisional Patent Application 60/860,952 filed on Nov. 27, 2006, entitled DEVICE AND METHOD FOR DETECTING AND MAINTAINING FLUID LEVEL IN A VESSEL, incorporated herein by reference.

### STATEMENT RE: FEDERALLY SPONSORED RESEARCH/DEVELOPMENT

Not Applicable

### BACKGROUND

The present invention generally relates to methods and devices to monitor fluid levels and, more particularly, to means for adjusting the level of fluids based on the fluid pressure in a vessel.

Determining the fluid level in a vessel is highly desired in many applications. For example, level monitoring devices typically use electronics to convert liquid level to a variable or signal, upon which more or less liquid is allowed into the vessel holding the liquid.

Some existing fluid-level-monitors use purely mechanical means for determining and controlling the level of fluid in a vessel. A major disadvantage of such mechanical systems, however, is their intrusiveness and difficulty in installing.

Other existing fluid-level monitors use electronics to either detect the level of liquid or to control the flow of liquid in and out of a vessel. A major disadvantage of these electronic systems is the need for a power source which increases the probability of failure from the electronic components.

Accordingly, what is needed in the industry is a non-invasive, easily installed, and non-electronic device for use in methods for monitoring and controlling the level of fluids in a vessel.

It is an object of the invention to obtain a measure of the level of fluid in a vessel. It is a further object of the invention to detect the fluid level without electronic devices or outside power source. It is also an object of the invention that the device for monitoring the fluid level in a vessel be inconspicuous. It is another object of the invention to be easily installed.

Some prior art methods for monitoring fluid pressure use a fluid pressure regulator (U.S. Pat. No. 7,048,001, issued to Youngberg et al.). Another example is a cut off switch that uses a magnetic switch and gauge (U.S. Pat. No. 4,736,077). One example of a remote monitor uses magnets to trigger alarms (U.S. Pat. No. 4,290,059).

Many prior art methods for monitoring fluid level use electronic components (U.S. Pat. No. 7,129,832). One low water indicator uses electrode powered by a battery (U.S. Pat. No. 5,835,018). Other prior art methods use vibrations to monitor the level of fluid (U.S. Pat. No. 7,039,530).

Some prior art devices use probes or other mechanical device within the vessel to measure the fluid or material level based on reflected microwave energy or a changed dielectric measurement (U.S. Pat. No. 6,178,817). Another probe generates pulsed signals (U.S. Pat. No. 5,943,908). One sensor uses a probe as a plunger attached to a tape or cable that descends into the vessel. (U.S. Pat. No. 5,651,285). One monitor uses an inverted U-shaped wave generator which is partially within the vessel (U.S. Pat. No. 5,031,451).

Another device uses a pair of transducers and pulse generators to monitor the fluid level in a tank (U.S. Pat. No. 5,015,995). Other prior art devices use microwaves to detect fluid levels using a prong inserted into the vessel (U.S. Pat. No. 6,988,404). Another prior art device uses high-frequency measurement signals and conductive elements (U.S. Pat. No. 6,847,214). Still another prior art system and method uses flexural waves to detect changes in liquid levels (U.S. Pat. No. 6,631,639).

One device uses an antenna to receive wave signals reflected off the surface of the filling substance (U.S. Pat. No. 6,614,391). One device for monitoring oil in an engine uses electronic control modules, and electronic warning device, and an electronic pump (U.S. Pat. No. 6,799,458). Another prior art device is a gravity valve that is typically used in horse watering and livestock watering systems.

Many of these prior art devices rely on outside power sources and electronics and/or internal mechanical components. For example, one monitor uses a battery operated circuit to create audible and visible signals of water levels (U.S. Pat. No. 5,428,348). While another device uses an optical photo sensor to detect water level in a pipe that is partially submerged in the vessel (U.S. Pat. No. 5,969,620).

The prior art devices have several drawbacks in that gravity valves must be installed directly under the vessel and the vessel itself must be suspended and the vessel must move to trigger the valve. Another example of a gravity valve is U.S. Pat. No. 6,488,058. This device uses a gravity valve to dispense a concentrated fluid for mixing with a diluant. Hence, the complexity of the device is unnecessarily increased and there is an inherent limit to the amount of fluid that can be monitored with any given gravity valve. Gravity valves must also be customized and are not easily used to retrofit existing vessels.

Another prior art device is a float valve such as in a toilet watering system. These float valves are relatively large and must be mounted within the monitored fluid vessel. Typically, these prior art devices are difficult to conceal.

A third prior art device uses electro-mechanical systems which include a sensing device and electrical system to control an electrical solenoid valve. A major disadvantage of electro-mechanical systems with a solenoid valve is that they rely on electronic control systems and on a power source of electricity. And electro-mechanical valves require a sensor to be mounted within or near the monitored vessel. These devices also are costly to build, install, and maintain and the sensors may be affected by factors other than fluid level.

One problem in the industry is that the source of fluid may be intermittent or periodic. When the source of the fluid is off, then the fluid pressure from the vessel may force the fluid out through the hose, thereby undesirably lowering the level of fluid in the vessel, and even emptying the vessel.

Further unmet demands in the industry include devices that will monitor and regulate large, small, and medium vessels without change or adaptation. Moreover, the industry would benefit from the costs savings available from using a device meeting the above needs. Thus, there is a need in the industry for relatively smaller devices that may be installed remotely or separately from the monitored fluid vessel. There is also a need for standard models that can be retrofitted easily in a variety of existing installations. There is also a need for self-actuated monitors that function without depending upon any power source.

### BRIEF SUMMARY

The fluid level regulator is a device and method for detecting and maintaining fluid levels within a vessel and controlling the level of the fluid by allowing fluid to flow into and out of the vessel in relation to the detected pressure.

The invention uses a fluid level regulator having a pressure detector that is inserted in a fluid line between the vessel and a fluid supply to ascertain the fluid pressure in the line, the pressure being proportional to the level of fluid in the vessel. The pressure regulator allows more or less fluid to flow in or out of the vessel based on the fluid pressure reading until the desired fluid level in the vessel is achieved. Once a pressure corresponding to a desired fluid level is achieved, a variable flow control valve or other device in the pressure regulator is activated to stop flow of the fluid into the vessel, thereby obtaining a desired level of fluid in the vessel without over and/or under filling the vessel. A check-valve can also optionally be connected to the hose to stop backflow of fluid from the vessel, which may be useful when the supply of fluid to the vessel is of a periodic type.

In one aspect of the invention, a kit having the fluid level regulator system is installed on a fountain, such as a decorative fountain for a garden or home, a birdbath, drinking fountain, or other similar vessel.

In another aspect of the invention, a kit having the fluid level regulator system is installed on a water tank, such as a water storage tank, home water heater tank, animal or livestock watering tank, a fish tank/aquarium, or other similar vessel.

Another aspect of the invention includes a kit having the fluid level regulator system that is installed to maintain a desired water level in a backyard or municipal pool or pond, spa, Jacuzzi or other similar vessel.

### BRIEF DESCRIPTION OF THE DRAWINGS

FIG. 1 shows a schematic view of a fluid vessel system having a fluid level regulator system and vessel that is adapted to regulate a level of fluid in the vessel.

FIG. 2 is a schematic top view of a fluid level regulator system that regulates a level of fluid in a vessel, the system having a level adjustment control to set a level of fluid in the vessel, and a check valve.

FIG. 3 is a schematic side view along cross-section 3 of the fluid regulator system shown FIG. 2.

FIG. 4 is a schematic bottom view along the cross-section 4 of fluid regulator system shown in FIG. 3.

### DETAILED DESCRIPTION

The accompanying drawings, which are incorporated in and form a part of this specification, illustrate embodiments of the invention and together with the description explain the principles of using the invention.

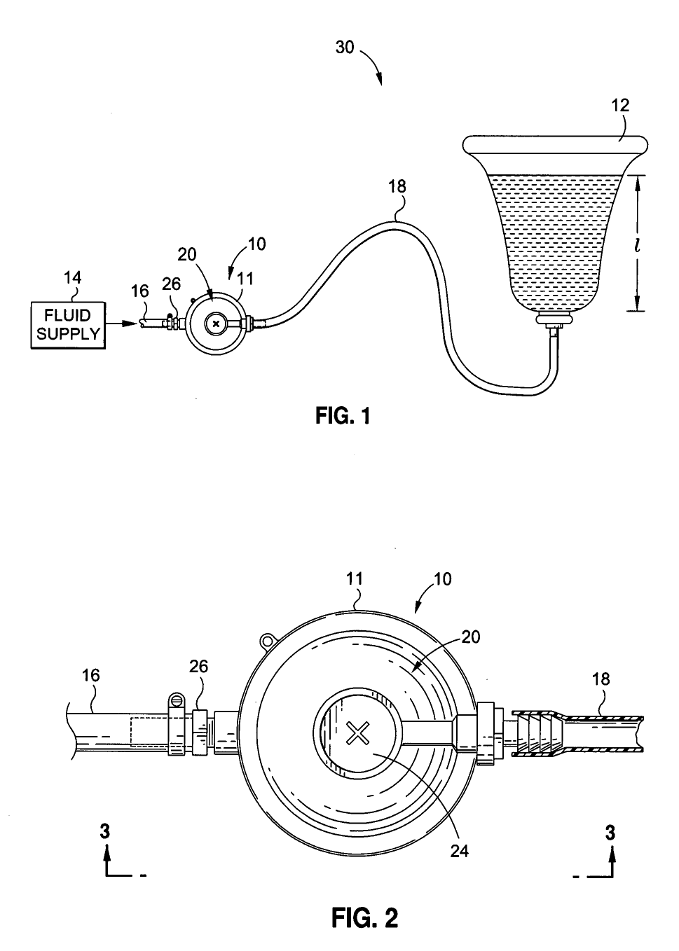

Referring to FIG. 1, when a hose or pipe is connected to a vessel containing a fluid, the pressure of the fluid can be measured if the hose is below the fluid level line in the vessel. The measured pressure of the fluid is proportional to the level of fluid in the vessel, with higher fluid levels generating greater pressures, and lower pressures being indicative of lower water levels.

A system 10 for regulating a level of fluid in a vessel 12 has been devised that detects a pressure of the fluid and regulates the level l of the fluid in the vessel 12 relation to this detected pressure. The system 10 comprises a fluid level regulator 11 that is inserted in a fluid line between fluid supply 14 and the vessel 12. In the version shown in FIG. 1, the fluid level regulator 11 is adapted to pass fluid therethrough, and is connected to an inlet hose 16 that provides a conduit for fluid to flow between the fluid supply 14 and the fluid level regulator 11. The regulator 11 is also connected to an outlet hose 18 that provides a conduit for fluid to flow between the fluid level regulator 11 and the vessel 12. The fluid level regulator 11 contains a pressure detector 20 that is capable of detecting a pressure of the fluid that is proportional to the level of fluid in the vessel 12, in effect providing a measure of the level of fluid in the vessel 12. The fluid level regulator 11 is capable of regulating this level in relation to the detected pressure, such as by increasing and/or decreasing a flow of fluid to the vessel 12, to provide a desired level of fluid in the vessel.

In one embodiment of operation of the system 10, fluid is introduced into the vessel 12 and the system 10 allows the vessel 12 to be filled to a desired or preselected fluid level and maintained at that level. Fluid is introduced into the system 10 by the fluid supply 14, passed through the fluid level regulator 11, and flowed to the vessel 12 to fill the vessel 12. The pressure detector 20 detects the pressure of the fluid in the fluid level regulator 11, and when the detected pressure reaches a predetermined pressure that is indicative of a desired fill level, the fluid level regulator 11 halts the flow of the fluid therethrough, to prevent overfilling of the vessel 12. The fluid level regulator 11 can also continuously monitor the pressure of the fluid and increase or decrease the fluid flow to achieve a preselected fluid level. For example, if the detected pressure is lower that a predetermined pressure corresponding to a desired fluid level, the flow of fluid to the vessel can be continued or even increased. If the detected pressure is higher than the predetermined pressure, a flow of fluid to the vessel can be decreased or even stopped. Thus, the level of fluid in the vessel can be automatically achieved and maintained, without over or under filling of the vessel 12.

In one version, the fluid level regulator 11 comprises a variable flow control valve or other valve 22 that can be used to increase and/or decrease the flow of fluid therethrough in relation to a pressure of the fluid. The valve 22 may be a mechanical valve of the self-actuating type, in that the valve automatically opens or closes in relation to a pressure of the fluid. The valve 22 can be biased for greater or lesser fluid flow according to a desired vessel fluid level, fluid fill time, and other factors. The fluid level regulator 11 can also comprise a level adjustment control 24 that can be adjusted by the user to set the level of fluid in the vessel 12, for example, the control 24 may adjust the valve bias to provide the desired rate of flow of fluid to the vessel 12 and to set a pressure corresponding to a desired fluid level at which the flow of fluid is stopped.

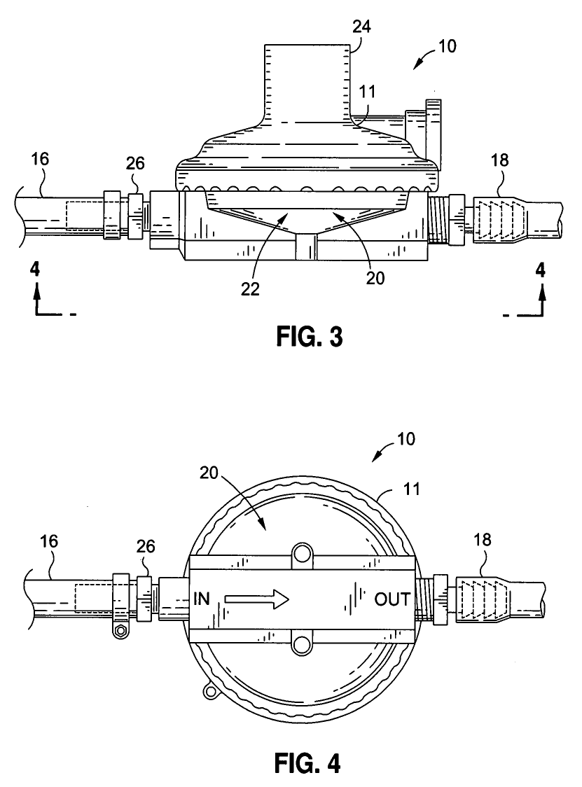

It is contemplated that the system 10 is capable of continuously regulating and maintaining a level of existing fluid in the vessel 12. For example, the system 10 is capable of determining when a level of fluid in the vessel 12 has become too low, such as due to evaporation or other external factors, by detecting a pressure that is related to the level, and allowing a flow of fluid to the vessel to replace the lost fluid when the detected pressure is below a predetermined pressure indicative of the desired fill level. The system 10 may also optionally contain a check valve 26 that acts to stop a flow of fluid out of the vessel 12. In FIGS. 2-3, the check valve 26 is positioned on the inlet hose 16 before the fluid level regulator 11 and after the fluid supply 14. Such a check valve 26 may be useful, for example, to maintain and/or regulate a level of fluid in the vessel when the system 10 is connected to a periodic or other non-continuous fluid supply. In such instances, a halt in the flow of fluid from the fluid supply 14 may result in an undesirable backflow of fluid from the vessel 12. The check valve 26 keeps the fluid from flowing out of the vessel 12 and system 10, and thus limits fluid losses to those small losses experienced from evaporation or the intended losses due to recreational or other use of the vessel 12. Such a check valve 26 may also be optional in instances where the fluid supply 14 provides a constant or continuous flow of fluid.

Accordingly, the fluid regulation system 10 provides an improved device to automatically regulate and maintain a level of fluid in a vessel 12, substantially without accidentally over or under filling of the vessel 12, and that is capable of compensating for periodic or non-constant flows of fluid. The system 10 is discrete and non-intrusive, and can be located remotely from the vessel 12 so that the system 10 does not interfere with the operation or aesthetics of the vessel 12. The system 10 also allows for a means of maintaining levels of water in the vessel without requiring continuous monitoring and manual refilling of the vessel 12 by the user of the vessel 12.

Some examples of fluid vessel systems 30 that can contain the fluid level regulating system 10 include those systems 30 having vessels 12 that are fountains, such as decorative fountains for gardens or homes, birdbaths, drinking fountain, or other similar vessels. Other vessels 12 can be water tanks, including water storage tanks, water heater tanks, animal or livestock watering tanks or troughs, and pet water bowls or water bottles, or other similar vessels. Also fish and reptile tanks or aquariums could serve as the vessel 12 in the system 30. The vessel 12 can also comprise a backyard or municipal pool or pond, spa, jacuzzi or other similar vessel.

It is noted that the invention can improve the function of livestock and other animal watering tanks and troughs. For the typical horse watering system with a gravity valve, the water vessel must actually move in order for the valve to allow water to enter the vessel. In contrast, the invention monitors the water level through water pressure and can detect low water levels without movement of the entire water vessel.

It is furthermore noted that the invention can improve the operation of ponds and bird baths which typically have an intermittent supply of water. For example, a check valve 26 can be provided to block a flow of water out of the pond or bird bath, while the regulating system 10 allows a flow of water into the pond or bird bath until the target water level is reached, thus minimizing the water loss to substantially only that due to evaporation.

The invention can also improve the appearance of decorative fountains by allowing the monitoring device to be installed remotely instead of as part of the fountain. For example, a length of the inlet and outlet hoses 16, 18 may be selected to allow remote installation and concealment of the fluid level regulator 11.

Additionally, the invention, by maintaining proper fluid level in the fountain, pond or pool, may prevent damage from occurring to other components that will not operate properly should the fluid level be too low. The invention is capable of improving the operation of small scale vessels and water systems such as toilets by providing a device that is both compact and inexpensive and that can be mounted outside the vessel.

The invention provides advantages for monitoring aquariums by enabling aquariums and industrial water and cooling systems with automatic fluid level control. The invention is an improvement over the prior art in several aspects, including but not limited to the following:

First, the fluid level regulator 11 of the invention can be self contained and require no outside power source.

Second, the fluid level regulator 11 of the invention can be small and easily concealed, allowing the fluid level regulator 11 to be installed either on a part of the vessel 12 or remotely from it without interfering with the vessel's operation or aesthetics.

Third, the fluid level regulator 11 of the invention allows easy installation in both new and existing vessels.

Fourth, the fluid level regulator 11 of the invention may be installed remotely. The inlet hose and the outlet hose may have any reasonable length hose connected, so that the monitored vessel may be a desired distance away from the monitoring device.

Fifth, the invention may be used with constant or intermittent sources of fluid.

It is noted that a preferred embodiment of the invention includes the check-valve 26 for use with intermittent fluid sources and a long outlet hose 18 for remote installation.

It is to be understood that the following claims are intended to cover all the generic and specific features of the invention as described herein. Alternative embodiments of the fluid regulating system are intended to be used in different configurations in various settings and application. With respect to the above description it is to be realized that the optimum dimensional relationships for the parts of the invention, including variations in its size, materials, shape, form, function, assembly, and use are deemed readily apparent and obvious to one skilled in the art. All equivalent relationships to those illustrated in the drawings and described in the specification are intended to be encompassed by the present invention. Therefore, the foregoing is considered as illustrative only of the principles of the invention.

Since numerous modifications and changes will readily occur to those skilled in the art, this presentation does not limit the invention to the exact construction and operation shown and described. All suitable modifications and equivalents fall within the scope of the present invention.

Together with the objects of the invention, various features of novelty are pointed out with particularity in the claims annexed to and forming a part of this disclosure. For a better understanding of the invention, its operating advantages and the specific objects attained by its uses, reference should be made to the accompanying drawings and descriptive matter and the preferred embodiments, as described above.

It is to be understood that the invention is not limited in its application to the details of construction and to the arrangement of the components set forth in the foregoing description or illustrated in the drawings. The invention is capable of other embodiments and of being practiced and carried out in various ways. In addition, the phraseology and terminology employed in this specification are for description and not limitation.

What is claimed is:

1. A system for regulating the level of fluid in a vessel, the system comprising:
a fluid level regulator adapted to pass a fluid therethrough, the fluid level regulator having a pressure monitor capable of detecting a pressure of the fluid;
an inlet hose connecting the fluid level regulator to a fluid supply; and
an outlet hose connecting the fluid level regulator to the vessel,
wherein the fluid level regulator regulates the level of fluid in the vessel by increasing and/or decreasing a flow of the fluid to the vessel in relation to the detected pressure of the fluid.

2. A system according to claim 1 wherein the fluid level regulator comprises a variable flow control valve that regulates a flow of fluid through the fluid level regulator and to the vessel in relation to the detected pressure.

3. A system according to claim 2 wherein the variable flow control valve is capable of increasing and/or decreasing a flow of fluid to the vessel to achieve a predetermined pressure indicative of a preselected level of fluid in the vessel.

4. A system according to claim 3 wherein the variable flow control valve is capable of stopping a flow of fluid to the vessel upon detection of the predetermined pressure.

5. A system according to claim 1 comprising a check valve to block a flow of fluid out of vessel.

6. A system of according to claim 1 wherein the fluid level regulator includes a level adjustment control adapted to set a level of fluid in the vessel in relation to the detected pressure.

7. A system according to claim 1 wherein the fluid supply is a water supply.

8. A method for regulating the level of fluid in a vessel comprising:
connecting a fluid level regulator having a pressure detector to a vessel;
flowing a fluid from a fluid supply through the fluid level regulator and to the vessel;
detecting a pressure of the fluid flowing through the fluid level regulator; and
increasing and/or decreasing the flow of the fluid to the vessel in relation to the detected pressure.

9. A method according to claim 8, wherein the fluid level regulator is positioned below the vessel and is connected to the vessel and fluid supply by first and second hoses.

10. A method according to claim 8 wherein the flow of fluid to the vessel is increased or decreased by actuating a valve in response to the detected pressure.

11. A method according to claim 10, wherein the valve is actuated to stop a flow of fluid to the vessel when a predetermined pressure indicative of a preselected level of fluid is detected.

12. A method according to claim 8 wherein the method comprises providing a check valve to stop a back flow of fluid from the vessel when the fluid supply is periodic.

13. A method according to claim 8 comprising regulating a level of water in the vessel.

14. A fluid vessel system having a regulated vessel fluid level, the system comprising:
a vessel capable of holding a fluid;
a fluid supply to provide the fluid to the vessel; and
a fluid level regulator system capable of regulating a level of fluid in the vessel, the fluid regulator system comprising:
a fluid regulator adapted to pass a fluid therethrough, the fluid level regulator having a pressure monitor capable of detecting a pressure of the fluid;
an inlet hose connecting the fluid level regulator to the fluid supply; and
an outlet hose connecting the fluid level regulator to the vessel,
wherein the fluid level regulator system regulates the level of fluid in the vessel by increasing and/or decreasing a flow of the fluid to the vessel in relation to a detected pressure of the fluid.

15. A fluid vessel system according to claim 14, wherein the vessel is a fountain, a bird bath, a water storage tank, an animal water trough, a pool or a pond.
